(19) United States
(12) Patent Application Publication
(10) Pub. No.: US 2002/0079193 A1
(43) Pub. Date: Jun. 27, 2002

(54) Cushioned stop for conveyor system

(76) Inventor: Evan M. Ormsby, Doraville, GA (US)

Correspondence Address: DICKINSON WRIGHT PLLC, Suite 800, 1901 L St., N.W., Washington, DC, 20036, US

(21) Appl. No.: 09/748,571

(22) Filed: Dec. 22, 2000

(51) Int. Cl. B65G 47/26

(52) U.S. Cl. 198/459.6

(57) ABSTRACT

The present invention is directed to a cushioned stop, and a cushioning assembly for use therein wherein the cushioning assembly includes a base, a carriage, and a spring assembly. The carriage is coupled to the base to move relative to the base between a forward position and a rearward position. The spring assembly includes a spring rod having a threaded segment, an adjustment nut having threads engageable with the threaded segment to couple the nut to the spring rod, and a spring operably coupled to the nut and the carriage to create a bias force. The bias force urges the carriage toward the forward position when the nut engages the threaded segment. The nut is axially movable along the rod to a released position out of engagement with the threaded segment to eliminate the bias force.

### BACKGROUND OF THE INVENTION

1. Technical Field

The present invention generally relates to conveyor systems using trolleys or carriers to transport material and, more particularly, to a trolley stop positioned in the conveyor system to selectively engage and stop passing trolleys.

2. Discussion

Conventional conveyor systems include a track, trolleys movable within the track to transport a load or workpiece, and a drive, such as a chain, that drivable engages the trolley. Stop mechanisms are commonly used to selectively stop passing trolleys at specific points along the conveyor path. Stops can be used for a variety of purposes including, for example, to hold a trolley at a workstation, control the flow of trolleys from point to point to prevent jams, and to protect the system or the payload as the trolley travels around tight curves.

Stops are commonly used in standard and inverted power and free conveyor systems with the stop blade positioned between the power and free tracks to selectively disengage the trolley from the power chain of the conveyor. Presently available stops commonly include a frame fixed to the conveyor track and a stop blade that is selectively movable relative to the frame between a retracted position out of engagement with the trolleys and an extended position where the blade extends into an interference position relative to the trolley travel path. The movement of the stop blade between its retracted and extended positions is commonly controlled by an actuator, such as an air cylinder, thereby permitting the stop to engage selected trolleys while permitting other trolleys to pass unrestricted. The stop blade may also be movable relative to the frame from a forward position to a rearward position when a trolley impacts the blade. A shock absorber can be used to dampen this blade movement thereby reducing the shock stress on the payload, trolley, and stop. Accordingly, when a moving trolley engages the stop blade, the blade moves from its forward position toward its rearward position as the shock absorber absorbs the kinetic energy of the moving trolley.

The prior art includes a variety of stop assembly configurations having the components generally described above and functioning in a generally acceptable manner. However, existing stop assemblies have several deficiencies that, to date, have gone unrecognized and/or unaddressed. For example, the art has failed to provide a stop assembly configuration that (1) permits efficient shipping, reassembly, and installation; (2) is conducive to efficient adjustment of the shock absorber capacity and return spring pre-load; (3) provides ready access to the spring assembly; and (4) permits disassembly of the unit for maintenance or repair in limited spaces.

### SUMMARY OF THE INVENTION

In view of the above, a need exists for a stop assembly configured to provide a compact configuration that can be disassembled in limited space and that provides an adjustable spring load. Accordingly, one object of the present invention is to provide a cushioned stop having a compact configuration during operation and that can be maintained and/or disassembled with less required clearance than prior art assemblies.

A further object of the present invention is to provide a cushioned stop having the stop blade positioned below the stop blade actuator and above the cushioning assembly to provide ready access to the spring and shock absorber assemblies and facilitate disassembly and maintenance.

Another object of the present invention is to provide a cushioned stop having a spring assembly that permits adjustment of the spring pre-load.

A still further object of the present invention is to provide a cushioned stop having a spring assembly with a threaded spring rod and cooperatively threaded adjustment nuts to permit adjustment of the spring pre-load.

Yet another object of the present invention is to provide a cushioned stop having a spring assembly that may be disassembled in a more limited space that prior art assemblies.

Another object of the present invention is to provide a cushioned stop having a spring assembly with a spring rod having a free end and a threaded segment spaced from the free end to permit cooperatively threaded adjustment nuts to be removed from threaded engagement with the spring rod.

Still another object of the present invention is to provide a modular cushioned stop that facilitates efficient shipping and installation.

In view of the above, the present invention is directed to a cushioned stop, and a cushioning assembly for use therein wherein the cushioning assembly includes a base, a carriage, and a spring assembly. The carriage is coupled to the base to move relative to the base between a forward position and a rearward position. The spring assembly includes a spring rod having a threaded segment, an adjustment nut having threads engageable with the threaded segment to couple the nut to the spring rod, and a spring operably coupled to the nut and the carriage to create a bias force. The bias force urges the carriage toward the forward position when the nut engages the threaded segment. The nut is axially movable along the rod to a released position out of engagement with the threaded segment to eliminate the bias force.

Further scope of applicability of the present invention and additional objects and benefits thereof will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is a top plan view of a conveyor system that includes a cushioned stop according to the present invention;

FIG. 2 is a sectional view taken along the line 2-2 shown in FIG. 1;

FIG. 3 is a top plan view of the cushioned stop of the present invention;

FIG. 4 is a sectional view of the cushioned stop taken along the line 4-4 shown in FIG. 3;

FIG. 5 is a top plan view of the cushioned stop that is similar to view of FIG. 3 but showing the absorber assembly in shadow so as to more clearly illustrate the stop blade assembly;

FIG. 6 is a left side elevation view of the stop blade assembly shown in FIG. 5;

FIG. 7 is a rear elevational view from the perspective of line 7-7 shown in FIG. 5 and illustrating the stop blade assembly;

FIG. 8 is a partial right side elevation view showing the actuator positions when the stop blade is in its retracted and extended positions;

FIG. 9 is a sectional view taken along the line 9-9 shown in FIG. 4;

FIG. 10 is a sectional view taken along the line 10-10 shown in FIG. 3; and

FIG. 11 is a sectional view of an alternate embodiment of the cushioning assembly taken generally along the same line as FIG. 10.

### DETAILED DESCRIPTION OF THE PREFERRED EMBODIMENT

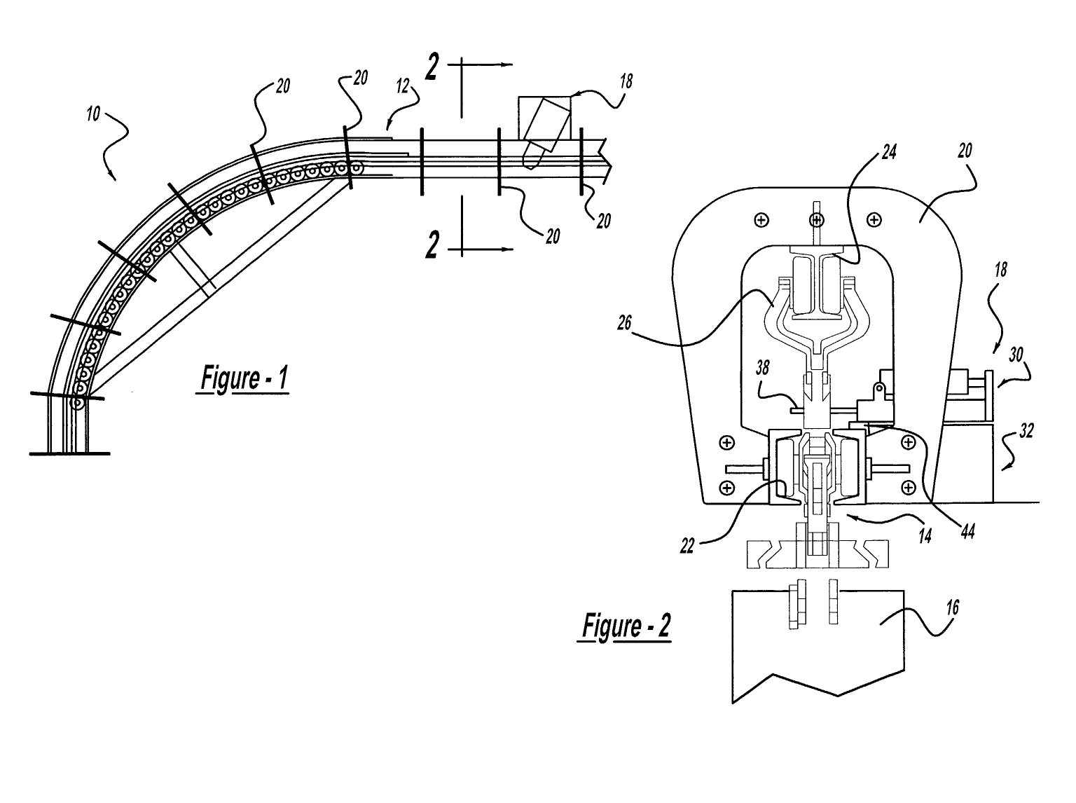

With reference to the drawings, and particularly FIGS. 1 and 2, the present invention generally relates to a conveyor system 10 having a track assembly 12 that supports trolleys 14 and workpieces 16 for movement through an assembly process. A cushioned stop 18 is coupled to the track assembly 12 which, in turn, is generally supported by yokes 20. In the illustrated embodiment, the conveyor system 10 is a power and free conveyor system with the track assembly 12 having a free track 22 disposed below a drive track 24. A drive mechanism 26 is disposed within the drive track 24 in operative engagement with the trolleys 14 which are movable within the free track 22. The cushioned stop 18 is positioned in operative engagement with the free track to selectively engage and stop the trolleys 14. In the preferred embodiment, the stop blade is positioned relative to the trolley to engage and lower a retractable dog on the trolley to disengage the trolley from the drive mechanism. It should be appreciated that while the present description and the attached drawings describe and illustrate the invention with regard to a standard power and free configuration, the stop blade of the present invention may also be used in other conveyor systems such as inverted power and free systems.

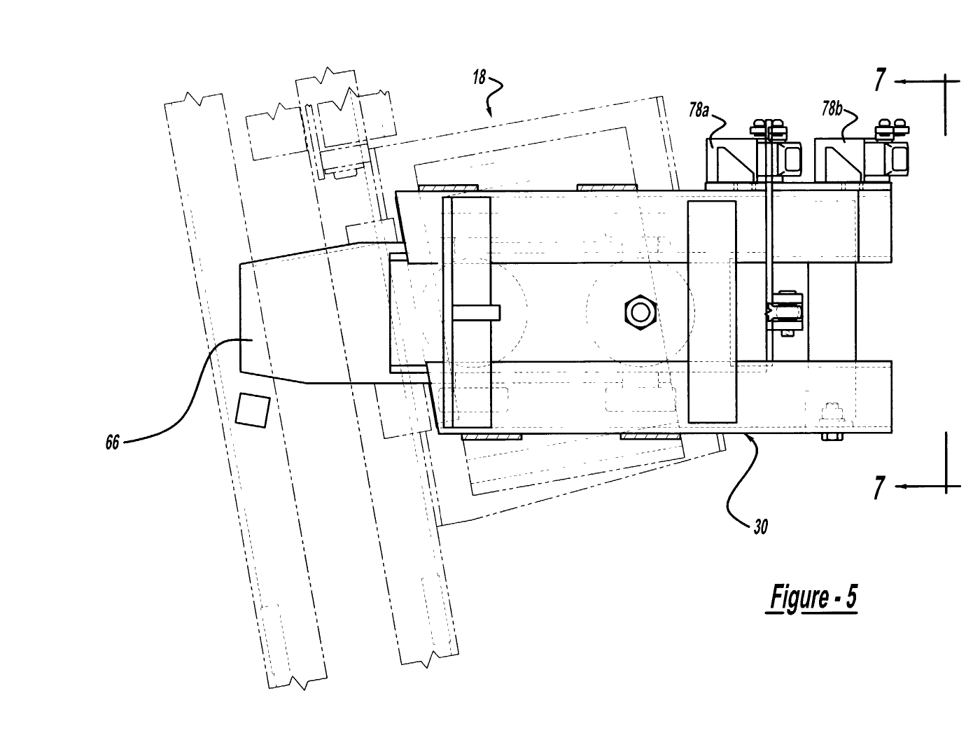

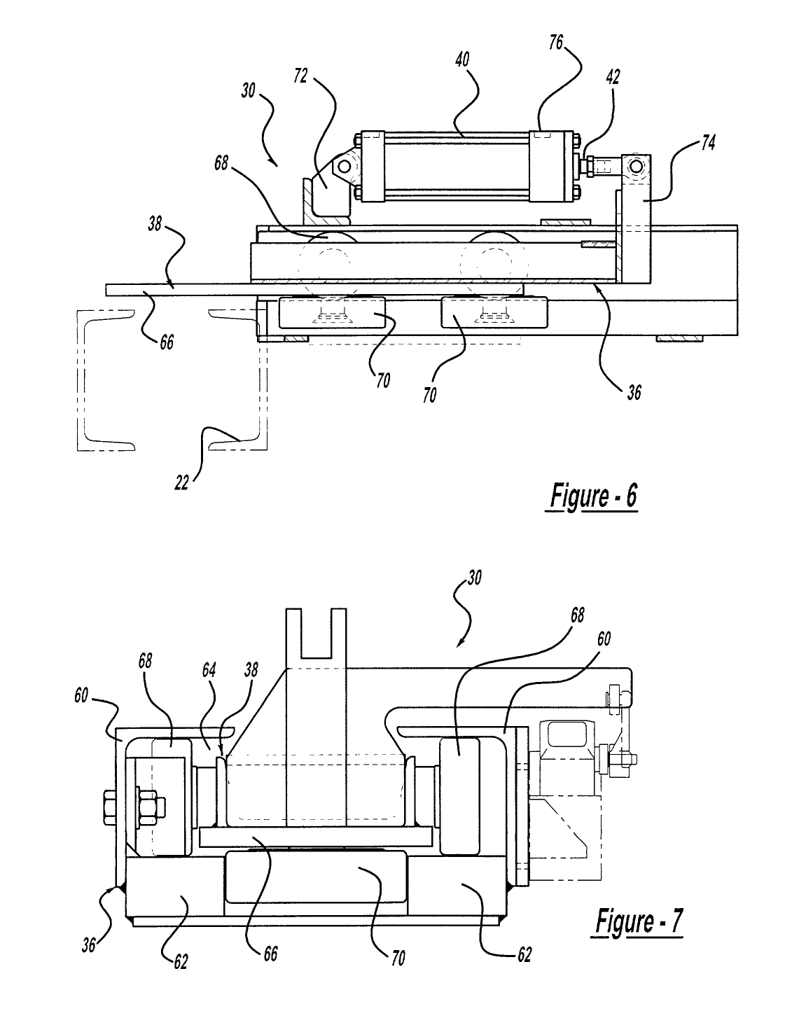

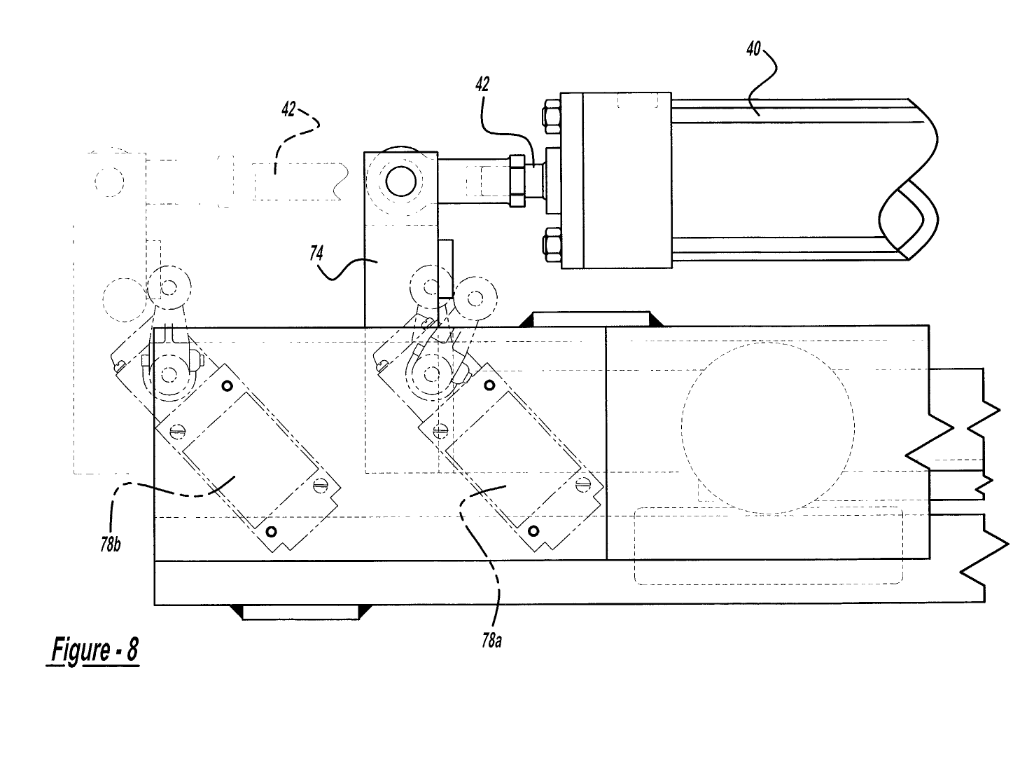

As is illustrated in FIGS. 2-4, the cushioned stop 18 generally includes a stop assembly 30 and a cushioning assembly 32. The stop assembly 30 (FIGS. 5-7) includes a frame 36, a stop blade 38 that is movable relative to the frame between an extended position and a retracted position, and an actuator 40. The actuator 40 is coupled to the frame 36 and stop blade 38 and is operable to selectively move the stop blade between its extended and retracted positions. More particularly, when the extendable actuator arm 42 is in the position shown in FIG. 6, the stop blade 38 is in the extended position. Conversely, movement of the actuator arm to the position shown in shadow in FIG. 8 displaces the stop blade away from the free track and out of operative engagement with the trolleys passing therethrough. Accordingly, when the stop blade 38 is in its retracted position the trolleys are free to pass the cushioned stop 18 without interference. However, with the stop blade 38 is in its extended position, the blade engages the passing trolleys.

The actuator 40 communicates with a controller (not shown) to permit selective positioning of the stop blade in its extended or retracted positions as is needed for movement of the trolleys and workpieces through the conveyor system. While a variety of control techniques generally known in the art may be used in appropriate circumstances, the stop blade is generally not moved to its retracted position unless there is room ahead of the stop for another trolley to enter and the previously released trolley is clear of a specific point. Limit switches, optical sensors, or other generally known sensing devices may be used to provide the desired input.

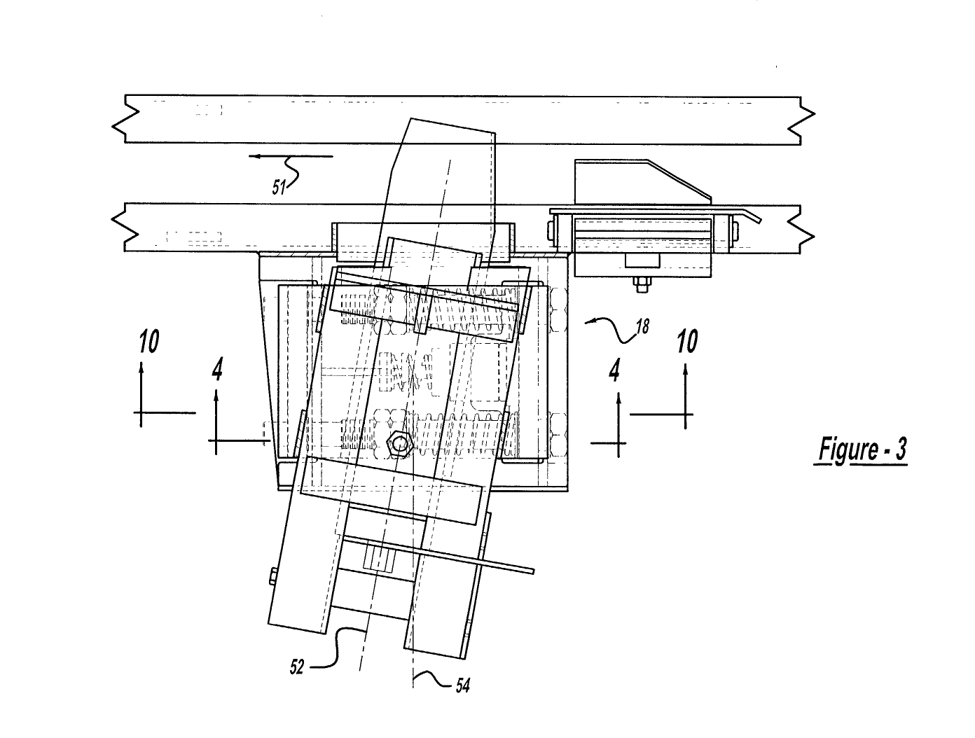

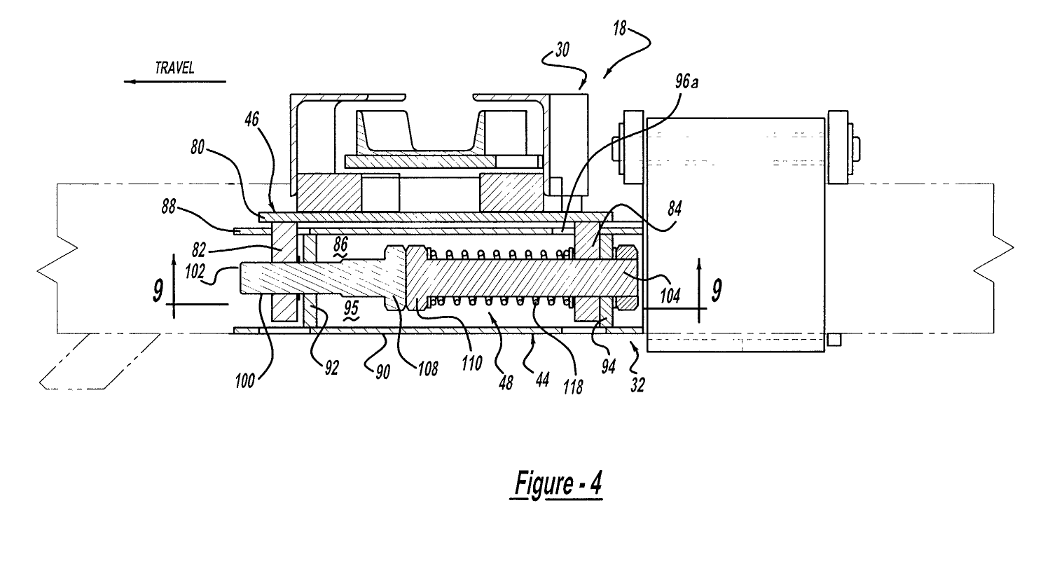

The cushioning assembly 32 (FIGS. 4, 9, and 10) generally includes a base 44, a carriage 46, a spring assembly 48, and a shock absorber 50. The carriage 46 is coupled to the base 44 for movement relative thereto in the direction of arrow 51 between a forward position (shown in FIG. 3) and a rearward position and the base 44 is fixed to the free track 22 (FIG. 2). The stop assembly frame 36 is fixed to move with the carriage 46 and has a skewed orientation relative to the cushioning assembly as illustrated by stop axis 52 and cushioning axis 54 (FIG. 3). In general, the stop blade 38 moves between its extended and retracted positions relative to the frame 36 in the direction of stop axis 52 whereas the carriage 46 and frame 36 move relative to the base 44 between the forward and rearward positions in the direction 51 of trolley movement, i.e., perpendicular to cushioning axis 54.

The shock absorber 50 and spring assembly 48 each act to resist or cushion movement of the carriage 46 from its forward position to its rearward position. More particularly, the spring assembly 48 creates a bias force that urges the carriage 46 to its forward position. As a result of the above configuration, when the stop blade 38 is positioned in its extended position, the approaching trolley impacts the stop blade 38 and, due to the momentum of the trolley, displaces the carriage 46 and the entire stop blade assembly 30 in the direction of arrow 51 against the bias of the spring assembly 48 and shock absorber 50. Thus, the stop assembly 30 is moved from its forward position toward its rearward position as the cushioning assembly 32 absorbs the kinetic energy of the trolley. When the trolley is brought to a stop, the bias of the spring assembly 48 urges the carriage 46 and stop assembly 30 back to its forward position.

The advantages of the present invention relative to prior art cushioned stops include (1) a spring assembly 48 configuration that provides an adjustable pre-load; (2) a cushioning assembly 32 configuration that includes a carriage cavity to provide relatively unobstructed access to the spring assembly 48 and shock absorber 50 thereby increasing the ease of maintenance and repair; (3) a spring assembly configuration that requires less clearance for disassembly, maintenance, and repair; (4) a modular overall cushioned stop that permits separate shipping and easier field installation; (5) a compact configuration that reduces the space requirements for the cushioned stop and permits the stop to be installed where limited yoke spacing is provided; and (6) various other structural modifications that improve the interchangeability of standard components, improve the reliability and operational life of the device, and generally facilitate assembly and operation. The specific structure of the stop assembly 30 and cushioning assembly 32 that provide each of the above discussed benefits, will now be discussed in greater detail.

As is best illustrated in FIGS. 5-7, the stop assembly frame 36 includes a pair of flanges 60 and bearing blocks 62 coupled to one another to define a blade cavity 64. The stop blade 38 generally moves within the blade cavity 64 and includes a plate 66 coupled to bearing wheels 68 and guide wheels 70. The bearing wheels 68 and guide wheels 70 permit movement of the stop blade 38 and, more particularly, the plate 66 thereof, between the retracted and extended positions. The actuator 40 is positioned above the stop blade 38 and includes a first end fixed to the frame 36 via a mounting bracket 72 (FIG. 5) and a second end movable relative to the first end and coupled to a mounting bar 74. By positioning the stop blade 38 between the actuator 40 and the cushioning assembly 32, access to the spring assembly 48 and shock absorber 50 via the bottom of the cushioning assembly 32 is maintained generally unobstructed.

In the illustrated embodiment, the actuator is an air cylinder actuator such as a heavy duty series 2AN actuator manufactured by Parker Hannifin Corp. of Corona, Calif. and includes an air discharge port 76 situated on the top side of the actuator 40. Those skilled in the art will appreciate that a variety of actuators, air cylinder and otherwise, may be used with the present invention without departing from the scope of the appended claims. Further, the connection of the actuator 40 to the bar 74 is preferably achieved through a ball joint eyelet 125 (FIG. 6) that is threaded onto the end of the cylindrical actuator rod 42. This connection permits adjustment of the position of the eyelet 125 on the rod 42 to accommodate misalignment between the moving blade 38 and the frame 36. The connection of the actuator 40 to the mounting bracket 72 is shown as a standard NFPA designated fixed rear clevis. While other connections known in the art may be used, the illustrated configuration provides, among other benefits, improved interchangeability of standard components. As noted above, the actuator communicates with a controller to selectively place the stop blade in its retracted and extended positions. To this end, the stop blade assembly preferably includes limit switches 78a and 78b (FIG. 8) fixed to the frame and positioned to be tripped by the moving mounting bar 74. By positioning the limit switches as illustrated, i.e., on the upstream and rear of the base 44, the switches do not interfere with the disassembly, maintenance, or repair of the cushioned stop.

The configuration of the cushioning assembly 32, and particularly the base 44, carriage 46, spring assembly 48, and shock absorber 50, will now be further described with reference to FIGS. 4, 9, and 10. As noted above, the carriage 46 is movable with the frame 36 and relative to the base 44 between forward and rearward positions perpendicular to axis 54 (FIG. 3). More particularly, the carriage 46 includes an upper member 80 to which the frame 36 is fixed for movement and first and second spaced legs 82 and 84 extending downwardly from the upper member 80 to define a carriage cavity 86. The base 44 includes a top 88, a bottom 90, and spaced and upstanding side walls 92 and 94 that define a base cavity 95. A cut-out 96 (FIGS. 4 and 9) is formed in the top 90, communicates with the base cavity 95, and is configured to receive the second carriage leg 84 to permit movement of the carriage leg 84 therewithin as the carriage 46 moves between its forward and rearward positions. The cut-out 96 preferably includes wings 96a and a center section 96b. As is discussed in greater detail below and most clearly illustrated in FIG. 9, the wings 96a are sized to limit movement of the carriage to a predetermined distance, “d” in the direction of the trolley movement, i.e., perpendicular to axis 54 (FIG. 3). By limiting the movement of the carriage, the magnitude of the predetermined distance depends upon the design loads and is preferably less than the stroke of the selected shock absorber so as to prevent damage to the shock absorber. Finally, the enlarged center section 96b provides clearance to mount a different or larger shock absorber.

The spring assembly 48 generally includes a spring rod 100 having a free end 102, a head end 104, and a threaded segment 106 (FIG. 9) therebetween. An adjustment nut 108 and a lock nut 110 are threaded to cooperate with the threaded segment 106 for adjustable positioning axially along the threaded segment. Each of the carriage legs 82 and 84 include an opening 112 and each of the base walls 92 and 94 include a passage 114 that are cooperatively positioned to accommodate the spring rod 100 as best illustrated in FIG. 9. A coil spring 118 is disposed between the adjustment nut 108 and the second carriage leg 84. By this arrangement, the position of the adjustment nut 108 determines a spring pre-load that urges the carriage 46 in the direction indicated by arrow 120, i.e., toward its forward position. The spring rod 100 also includes a reduced diameter and non-threaded segment 116 between the threaded segment 106 and the free end 102.

When it is desired to eliminate the spring pre-load or to completely disassemble the cushioning assembly 32, the adjustment and lock nuts 108 and 110 may be axially displaced from the threaded segment 106 and into a released position in the non-threaded segment 116. In this position, the spring rods 100 are axially displaceable out of the upstream end openings 112 and passages 114. This arrangement permits the springs to be removed from about the rods and/or the cushioning assembly to be disassembled in tighter spaces than was permitted with prior art devices. More particularly, the springs may be removed from about the rod by displacing the rods toward the right as shown in FIG. 4. When the rod has been displaced a sufficient distance, approximately eleven inches in the illustrated embodiment, the spring may be removed from about the rod. Moreover, additional displacement of the rod 100 to the right, an additional four inches in the illustrated embodiment, completely removes the spring rods from the carriage legs and base walls thereby permitting disassembly of the carriage and base. Thus, the axial length of the reduced diameter segment 116 in the preferred embodiment is approximately four inches. This length is dictated in part by the distance that the carriage travels along the rod during the fully shock absorber stroke, the thickness of the first leg 82 and side wall 92, and the thickness of the nuts 108 and 110.

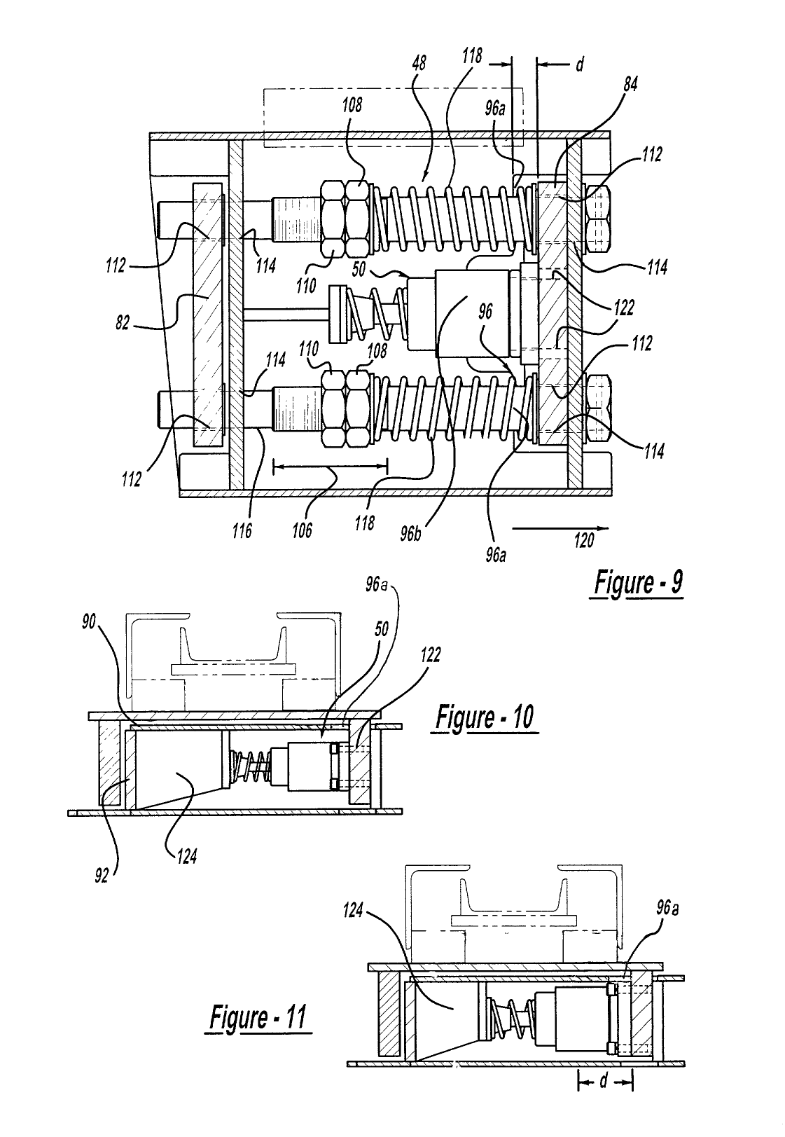

Finally, the shock absorber 50 is disposed between the second carriage leg 84 and the base side wall 92. The shock absorber is configured in a manner known in the art so as to dampen movement of the carriage leg 84 relative to the side wall 92 and thereby absorb the force of the trolley impacting the stop blade. The illustrated shock absorber is coupled to the second carriage leg 84 by threaded bolts or other removable fasteners disposed in wall apertures 122. An impact gusset plate 124 (FIG. 10) is positioned between the shock absorber 50 and the base side wall 92. The gusset plate 124 permits the size and load capacity of the shock absorber to be selected based upon the desired design loads and shock absorber stroke. More particularly, the gusset plate 124 may be of virtually any axial length that permits the shock absorber to operate within its design parameters.

By way of example, a four and one-half inch gusset plate 124 is shown in FIG. 10 for use with a shock absorber having a one-inch stroke and a design capacity of 2,300 inch-pounds. Accordingly, the configuration of the cut-out wings 96a in the base top 90 allows the carriage leg 84 to move a maximum travel distance “d” of ⅞ of an inch. This travel limitation leaves the last ⅛ inch of stroke unused to prevent “bottoming-out” of the shock absorber. As a further example, FIG. 11 generally shows another embodiment where a one and three-eighths inch gusset plate 124 is used with a 6,000 inch-pound shock absorber having a nominal two inch stroke. In this configuration, the cut-out wings 96a are of sufficient size to provide a travel dimension “d” of 1⅞ inches. It should be appreciated that the specific dimensions and capacities are provided for exemplary purposes only and may be varied based upon specific design parameters.

As a result of the above configuration, those skilled in the art will appreciate that the cushioned stop of the present invention has a compact configuration, provides improved clearance from the conveyors and carriers, has improved accessibility to the spring assembly and shock absorber, and is of a modular construction permitting separate shipment of the stop assembly, actuator, and cushioning assembly thereby providing easier handling and field installation.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A cushioning assembly for use in a cushioned stop that stops trolleys moving within a conveyor track, said absorber assembly comprising:
a base;
a carriage coupled to said base to move relative to said base between a forward position and a rearward position; and
a spring assembly including a spring rod having a threaded segment, an adjustment nut having threads engageable with said threaded segment to couple said nut to said spring rod, and a spring operably coupled to said nut and said carriage to create a bias force urging said carriage toward the forward position when said nut engages said threaded segment, said nut being axially movable along said rod to a released position out of engagement with said threaded segment to eliminate said bias force.

2. The cushioning assembly of claim 1 wherein said carriage includes first and second legs spaced from one another to define a cavity, wherein said spring rod has a head end and a free end, said head and free ends extending outside said cavity, said threaded segment being within said cavity.

3. The cushioning assembly of claim 2 wherein said threaded segment includes a terminal end spaced from said free end of said rod and wherein said threaded segment extends from said terminal end toward said head end of said spring rod.

4. The cushioning assembly of claim 3 wherein said spring rod is free of threads between said terminal end and said free end.

5. The cushioning assembly of claim 3 wherein said base includes a top coupled to said first and second walls and having a cut-out extending through said top and wherein one of the legs is disposed for movement in the cut-out between said forward and rearward positions.

6. The cushioning assembly of claim 1 wherein the axial position of said nut along said rod is adjustable within said threaded segment to define an adjustable spring pre-load defining the bias force acting on said carriage when said carriage is in said forward position.

7. The cushioning assembly of claim 1 wherein said spring rod is removable from engagement with said base and said carriage when said adjustment nut is in said released position.

8. The cushioning assembly of claim 7 wherein said adjustment nut is between said threaded segment and said free end when said adjustment nut is in said released position.

9. The cushioning assembly of claim 2 wherein said carriage includes a top, said legs depend downward from said top such that said cavity opens away from said top to define an access opening to said spring assembly.

10. A cushioned stop for use in a conveyor system to stop trolleys moving within a conveyor track, said cushioned rolling stop comprising:
a cushioning assembly having a base, a carriage, and a spring assembly, said carriage coupled to said base to move relative thereto in a first direction from a forward position toward a rearward position and a second direction opposite said first direction, said spring assembly being operably coupled to said carriage and said base to urge said carriage in said second direction;
a stop assembly coupled to said carriage to move with said carriage between said forward and rearward positions; and
wherein said cushioning assembly further includes a shock absorber coupled to said carriage to dampen movement of said carriage toward said rearward position and wherein said spring assembly includes a spring rod having a threaded segment, an adjustment nut having threads engageable with said threaded segment to couple said nut to said spring rod, and a spring operably coupled to said nut and said carriage to create a biasing force urging said carriage in said second direction when said nut engages said threaded segment, said nut being axially movable along said spring rod to a released position out of engagement with said threaded segment to eliminate said bias force.

11. The cushioned stop of claim 10 wherein said carriage includes first and second legs spaced from one another to define a cavity, wherein said spring rod has a head end and a free end, said head and free ends extending outside said cavity, said threaded segment being within said cavity.

12. The cushioned stop of claim 11 wherein said threaded segment includes a terminal end spaced from said free end of said rod, wherein said threaded segment extends from said terminal end toward said head end of said spring rod, and wherein said spring rod is free of threads between said terminal end and said free end.

13. The cushioned stop of claim 10 wherein said base includes a top coupled to said first and second walls and having a cut-out extending through said top, wherein said carriage extends into the cut-out for movement between said forward and rearward positions, and wherein said cut-out is configured to limit the travel of said carriage to prevent the carriage movement from exceeding the shock absorber stroke.

14. The cushioned stop of claim 10 wherein said stop assembly includes a stop blade and an actuator, said stop blade being coupled to said carriage for movement relative to said carriage between an extended position and a retracted position and for movement with said carriage between a forward position and a rearward position, said actuator being coupled to said carriage and said stop blade to move said stop blade between said retracted position and said extended position, said stop blade being positioned between said actuator and said cushioning assembly and said actuator being above said stop blade.

15. A conveyor system comprising:
a track having a channel configured to accommodate trolleys for movement within said channel;
a cushioned stop fixed to said track and having a stop assembly extending into operative engagement with said channel, said cushioned stop including an absorber assembly having a base, a carriage, and a spring assembly, said carriage coupled to said base to move relative thereto in a first direction from a forward position toward a rearward position and a second direction opposite said first direction, said stop assembly being coupled to said carriage to move with said carriage between said forward and rearward positions, and wherein said spring assembly includes a spring rod having a threaded segment, an adjustment nut having threads engageable with said threaded segment to couple said nut to said spring rod, and a spring operably coupled to said nut and said carriage to create a biasing force urging said carriage in said second direction when said nut engages said threaded segment, said nut being axially movable along said spring rod to a released position out of engagement with said threaded segment to eliminate said bias force.

16. A cushioned stop comprising:
a cushioning assembly having a base and a carriage coupled to said base to move relative thereto in a first direction from a forward position toward a rearward position and a second direction opposite said first direction;
a stop assembly coupled to said carriage for movement relative to said carriage between an extended position and a retracted position and for movement with said carriage between said forward and rearward positions; and
wherein said stop assembly further includes an actuator coupled to said carriage and said stop assembly to move said stop assembly between said retracted position and said extended position, said stop assembly being positioned between said actuator and said cushioning assembly and said actuator being above said stop assembly.

17. The cushioned rolling stop of claim 16 wherein said actuator includes an air cylinder having topside discharge ports to discharge air in a direction away from said carriage.

18. The cushioned stop of claim 17 wherein said cushioning assembly further includes a spring assembly having a spring rod with a threaded segment, an adjustment nut with threads engageable with said threaded segment to couple said nut to said spring rod, and a spring operably coupled to said nut and said carriage to create a bias force urging said carriage in said second direction when said nut engages said threaded segment, said nut being axially movable along said rod to a released position out of engagement with said threaded segment to eliminate said bias force.
